(19) United States
(12) Patent Application Publication
(10) Pub. No.: US 2012/0191691 A1
(43) Pub. Date: Jul. 26, 2012

(54) METHOD FOR ASSESSING AND IMPROVING SEARCH ENGINE VALUE AND SITE LAYOUT BASED ON PASSIVE SNIFFING AND CONTENT MODIFICATION

(76) Inventor: Robert Hansen, Austin, TX (US)

(21) Appl. No.: 12/420,039

(22) Filed: Apr. 7, 2009

Related U.S. Application Data
(60) Provisional application No. 61/042,937, filed on Apr. 7, 2008.
(60) Provisional application No. 61/107,727, filed on Oct. 23, 2008.

(51) Int. Cl. G06F 17/30

(52) U.S. Cl. 707/709; 707/E17.108

(57) ABSTRACT

A method for determining the value of a given page or pages in aggregate to a search engine based on key-word search results and optionally modifying the outbound results to optimize the value and layout of the page or pages. A listening system is inserted within the network for the purpose of listening to both inbound to and outbound traffic from the web server and optionally modifying outbound responses. The device uses an algorithm to decide the relative value of the page as it is traversed. The system also detects web server errors, scanning depth of the search engine and makes recommendations based on the examined traffic and desired results. Human visitors are distinguished from search engines by looking at the HTTP headers and therefore search engine depth and effectiveness in page scanning can be calculated.

### CROSS-REFERENCE TO RELATED APPLICATIONS

The present U.S. Utility Patent Application claims priority pursuant to 35 U.S.C. §119(e) to the following U.S. Provisional Patent Applications which are hereby incorporated herein by reference in their entirety and made part of the present U.S. Utility Patent Application for all purposes:

1. U.S. Provisional Application Ser. No. 61/042,937, entitled METHOD FOR ASSESSING SEARCH ENGINE VALUE BASED ON PASSIVE SNIFFING,” (Attorney Docket No. RHAN P001USP) filed Apr. 7, 2008, pending.

2. U.S. Provisional Application Ser. No. 61/107,727, entitled METHOD FOR ASSESSING AND IMPROVING SEARCH ENGINE VALUE AND SITE LAYOUT BASED ON PASSIVE SNIFFING AND CONTENT MODIFICATION,” (Attorney Docket No. RHAN P002USP) filed Oct. 23, 2008, pending.

### BACKGROUND OF THE INVENTION

The present disclosure relates generally to search engines, and more particularly, a system and method of detecting and improving the relative rankings of web pages listed within search engines in the natural or unpaid search engine results.

### BRIEF SUMMARY OF THE INVENTION

Embodiments of the present disclosure are directed to systems and methods that are further described in the following description and claims. Advantages and features of embodiments of the present disclosure may become apparent from the description, accompanying drawings and claims.

Embodiments of the present disclosure provide systems and method for assessing and improving search engine value and site layout based on passive listening and content modification. A first embodiment provides a method that includes passive listening to HTTP or HTTPS traffic to or from a site. By listening, processing modules associated with the present disclosure may identify a type of user such as a robotic user or a human visiting the site.

Furthermore, the intent of the user may also be identified whether it is benign or malicious. The HTTP or HTTPS traffic may be longed (recorded) for analysis of the pages (content) visited and the results associated with those page visits. This analysis of the traffic and traffic results may result in identifying potential optimizations to content. Further steps may include implementation of those optimizations. Potentially those optimizations may be done in real time or near real time.

The passive listening may be performed by a processing module either in line, in parallel (out of line), or in memory on the web site. The results examined may identify conversion rates associated with those results where those conversion rates relate to the implementation of a sale associated with the pages that have been visited. Then the optimization may relate to changes in keywords or metadata associated with the visited pages and the path leading to those visited pages such that the keywords or metadata are optimized based on the conversion rate.

The reconfiguring of the web site or content in real time may also be performed based on the type of user visiting the site. For example, for a robotic user such as a spider or crawler, there may be content that may not be revealed to the robotic user while a more robust content is revealed to a human user. Similarly, depending on the intent associated with the visit content may be hidden as well. The analysis may track changes associated with the web site to include the ability to manually or automatically track changes associated with feeder sites leading to the web site.

Another method provided by embodiments of the present disclosure includes listening for traffic as traffic traverses a network node. Content within this traffic may be algorithmically inspected for processing in real time and/or post processing. Changes to improve the individual page rankings for content associated with the web site may be recommended based on the search engine results for each page within the web site when the rankings associated with that page are determined to have declined or be less attractive to search engine spiders. This may also be done when the attractiveness of those pages or content falls below a predetermined or user defined threshold.

Data may be logged and retained to provide statistical knowledge of changes to the web site content and feeder sites or sources of traffic as those change over time. Other knowledge maintained may be the construction of a site map based on difference between human users and robotic users, tracking a number and location of links and the frequency to which those links are indexed, and a change over time of how viewing depth or traffic depth associated with the site changes.

Another embodiment provides a method that first logs referring addresses of pages originating from known search engines. Keywords may then associate with those addresses as well as user-inputted high-value keywords associated with the searches. This allows one to determine how valuable each page is in regards to relevant keywords and/or metadata. Then they keyword density and location or other metadata density and location may be optimized based on the value assigned to individual pages.

Yet another embodiment provides a method that involves first passively listening to data traffic associated with a network site. Spiders or robotic users visiting the network site may then be identified by their traffic. Information associated with this traffic may then be logged and analyzed as well as any results associated with visits to the network sites. The logged information may be analyzed in order to determine robotic users such as spiders or crawlers that exhibit malicious or non-benign behavior. The data content associated with the network site may be modified such that data may be redacted in order to not provide content to a robotic user. Furthermore, a report of the non-benign robotic users may be generated and provided for further analysis and actions.

Yet another method associated with embodiments of the present disclosure involves again first passively listening to traffic associated with a network site. This traffic again may be logged for analysis to include analysis of the pages visited and the results associated with those pages. Effectiveness of keywords or metadata may be determined by analyzing the logged traffic. This may identify the effectiveness of keywords within various search engines by logging and dissecting search engine results from referring addresses. Then they keyword density and location may be optimized based on the effectiveness of the keywords within those searches.

A further embodiment associated of the present disclosure involves passively listening to traffic associated with the network site. This traffic may be logged for analysis of the pages or content visited and the results associated with those visits. Then outbound responses from the network site may be modified to introduce new components from the web site based on the analysis of the logged information.

### BRIEF DESCRIPTION OF THE SEVERAL VIEWS OF THE DRAWINGS

For a more complete understanding of the present disclosure and the advantages thereof, reference is now made to the following description taken in conjunction with the accompanying drawings in which like reference numerals indicate like features and wherein:

FIG. 1 is a network topology logical diagram that shows how a system in accordance with embodiments of the present disclosure would be deployed in an out of line mode;

FIG. 2 provides a screenshot of an Internet Browser which may be utilized in accordance with embodiments of the present disclosure;

FIG. 3 is a network topology logical diagram that shows how a system in accordance with embodiments of the present disclosure would be deployed in an in line mode;

FIG. 4 is a logical diagram explaining how embodiments of the present disclosure would be deployed as an in-memory process, or web server module;

FIG. 5A provides a logic flow diagram illustrating a method for recommending optimizations to the web page based on search engine results;

FIG. 5B provides a logic flow diagram illustrating another method for recommending optimizations to the web page based on search engine results;

FIG. 6A provides a logic flow diagram in accordance with embodiments of the present disclosure of a method of making recommendations to improve page rankings within search engine results;

FIG. 6B provides a logic flow diagram in accordance with embodiments of the present disclosure of a method of making recommendations to improve page rankings within search engine results;

FIG. 7A provides a logic flow diagram of a method of optimizing keyword to understand the location based on the location and keywords on a web site page in accordance with embodiments of the present disclosure;

FIG. 7B provides a logic flow diagram of a method of optimizing keyword to understand the location based on the location and keywords on a network site page in accordance with embodiments of the present disclosure;

FIG. 8 provides a logic flow diagram of a method of modifying outbound responses from the web server for the purpose of improving page construction for page load time optimization, adding third party in line widgets, or improving the search engine value of the page;

FIG. 9A provides a logic flow diagram associated with method of optimizing web sites in accordance with embodiments of the present disclosure; and

FIG. 9B provides a logic flow diagram associated with method of optimizing network sites in accordance with embodiments of the present disclosure.

### DETAILED DESCRIPTION OF THE INVENTION

Preferred embodiments of the present disclosure are illustrated in the FIGs., like numerals being used to refer to like and corresponding parts of the various drawings.

The present disclosure generally relates to a system of detecting the relative rankings of web pages listed within search engines in the natural or unpaid search engine results.

Specifically by passively listening on the wire, a system can determine mistakes made that would reduce the ability for search engines to properly index and rank a web site. The recommendations would allow a web site to be modified to improve the relative rankings within the search engine—also known as search engine optimization (SEO).

The present disclosure presents a system and method of tracking HTTP traffic to and from a web site for the purpose of analyzing the search engine rankings of each page requested and optionally changing the response. The analysis will help web sites perform self-improvement to increase their rankings within search engine keyword query results. Embodiments of the present disclosure place a monitoring module physically located in a place operable to passively listen to data transported across the network interfaces and then correlate and identify problems associated with that data and report that information. A secondary consideration allows the data to be modified at these network interfaces in order to improve search engine optimization or to put in search engine marketing (SEM) campaigns or AB testing. Search engine marketing data may be in the form of flash or java or any other type script known to those skilled in the art.

A device will be placed in line between the Internet and the web servers for replication of traffic to the system for analysis. The replication device can be a network tap, a switch using a SPAN port, a hub, a load balancer or other network equipment that can capture, replicate and optionally modify web traffic. In this way, the system is exposed to both inbound HTTP traffic to the web server as well as outbound pages and errors emitted from the web server.

The system, once exposed, monitors requests to identify which requests are originating from a spider based on IP addresses, requests to robots.txt or other HTTP headers that indicate a spider. Identifying which pages the spider has been able to access over time allows the system to build reporting against all the known pages that all normal users have been able to access that the spider may have been unable to locate.

The system also identifies users who are attempting to fool the web server into believing they are search engines by analyzing the user's HTTP headers against a database of known HTTP headers for the spider in question.

The system also sees outbound HTTP server responses, which indicates success or failure based on known responses. Either typical HTTP error responses or custom error pages indicate that a bot (spider or crawler) has found a page that is either configured incorrectly or it is missing.

The system can optionally modify outbound web server responses to add in relevant content, delete redundant content, change content to be more attractive to search engines or re-route traffic through redirection to more optimized web pages. This information is gleaned from both automated rules engines as well as manual rules placed into the system.

In an in line mode, the system can optionally modify header and footer information for site-wide consistency with policy conformance, copyright information, current navigation and so on. This can optionally be different on a page-by-page basis depending on the rules placed into the engine for creating easier navigation (i.e. sub categories within a hierarchical navigational structure) for both users and spiders.

In an in line mode, the system can optionally integrate third party widgets into the outbound response. These third party widgets could include text or banner advertisements, tracking analytics software, A/B testing software, feedback tools, online polls and so on. Third party content could contain HTML, images, JavaScript, VBScript, CSS, Silverlight, Java, Flash, movies, audio and so on. These widgets can be inserted dynamically into the page at set points by an in line device based on custom rules available to the system, which can dramatically speed up integration time. Rules could include placement on the page narrowed down by rules associated with directory paths, credentials, or other HTTP headers or content on the page, as denoted by rules placed in the system. Rules could also be dynamic and change based on usage, percentage of traffic flow, by geographic region, time of day or other arbitrary rules, to include third party widgets only some of the time or for use in targeted widget placement.

In an in line mode, the system can also optionally identify heavy page or image/object usage and offer advice on how to improve pages or modify the content dynamically on the fly to optimize their efficiency (i.e. remove superfluous markup or text and reduce redundant information) to improve page load time for search engines and users, while reducing overall bandwidth usage. For example, in the case of images, the system could identify extraneous EXIF information within JPEG images and could clean the images by removing the EXIF information and cache the modified content to improve site performance.

Page layout is analyzed by the system against a set of rules within a configurable database to detect the relative quality of the page as it relates to the known parameters that the various spiders of interest use to assess page rank. Page importance as it relates to the owner of the web site is both customizable and measured by the number of visitors to that web page over time, indicating the relative priority of optimization.

The system will create dynamic search engine Sitemaps based on a rolling known set of URLs based on the pages hit over time as well as correlate that against the robots.txt files and other page tags that indicate they do not belong in the Sitemap.

Search engines presently use “spiders” or “crawlers” to navigate, locate and index web sites for displaying results to keyword searches on their search engine results pages. Using internal and typically unpublished algorithms, search engines decide which pages should be surfaced for any given keyword based search. In this case, search engines include but are not limited to companies like Google, Yahoo, Ask, and MSN.

Search engines can either intentionally opt to avoid indexing a web site based on unattractiveness of the site in question, or more likely simply cannot find the site due to complex web application design. Some modern web applications use dynamic browser based scripting, like JavaScript, Flash and other tools to generate navigation links, which is often technically challenging for a search engine to traverse. However, normal users have an easy time traversing links of this kind.

Search engines also find web pages that are missing content, are poorly structured, have low keyword density are too long, and other similar parameters to be less attractive. There are dozens of potential parameters used by each of the individual search engines that can and often do change over time that could cause a web site to be less attractive than another site of otherwise equal public perception.

JavaScript based or pixel based tracking is often used in lieu of server side logging. These tools have some levels of insight into the traffic of a web site, but only for normal users. This is only slightly less problematic, as normal users most often send referring URLs identifying which keywords were typed in and from which search engines. However, typically JavaScript and tracking pixels will not be followed by search engine spiders or will not give the context of how they arrived at the page via a referring URL, making them severely less efficient at tracking a spider's movement.

“Robots.txt” files, meta HTML tags and rel=“nofollow” are used to limit a well behaved search engine's rights when traversing a web site in terms of reducing the search engine's rights to spider or index. These files are often written to exclude too much or too little, causing a search engine to find more than it should find, or less than it should, respectively Likewise another file format called “Sitemaps” are used by certain search engines to illicit them to spider pages that are otherwise difficult for a search engine spider to locate and therefore index.

Attractiveness of a web site is determined explicitly by a web site's ability to conform to the individual search engine's model of relevance. Although somewhat subjective, relevance can be measured and studied as the result of changes made to any individual web page or collection of web pages will either increase or decrease the relevance and therefore position on the page in reference to competitors who do not perform SEO.

Currently there exists no system to help aid in optimization of search engine crawling and improvements to overall site quality as it relates to search results. Further measuring effectiveness of search engine crawlers is currently only possible by making often times radical changes to logging infrastructure. Therefore, a need exists to create a platform that does not require any changes to the application, logging, or deploying any self-spidering technology to gain visibility into the application's attractiveness to search engines.

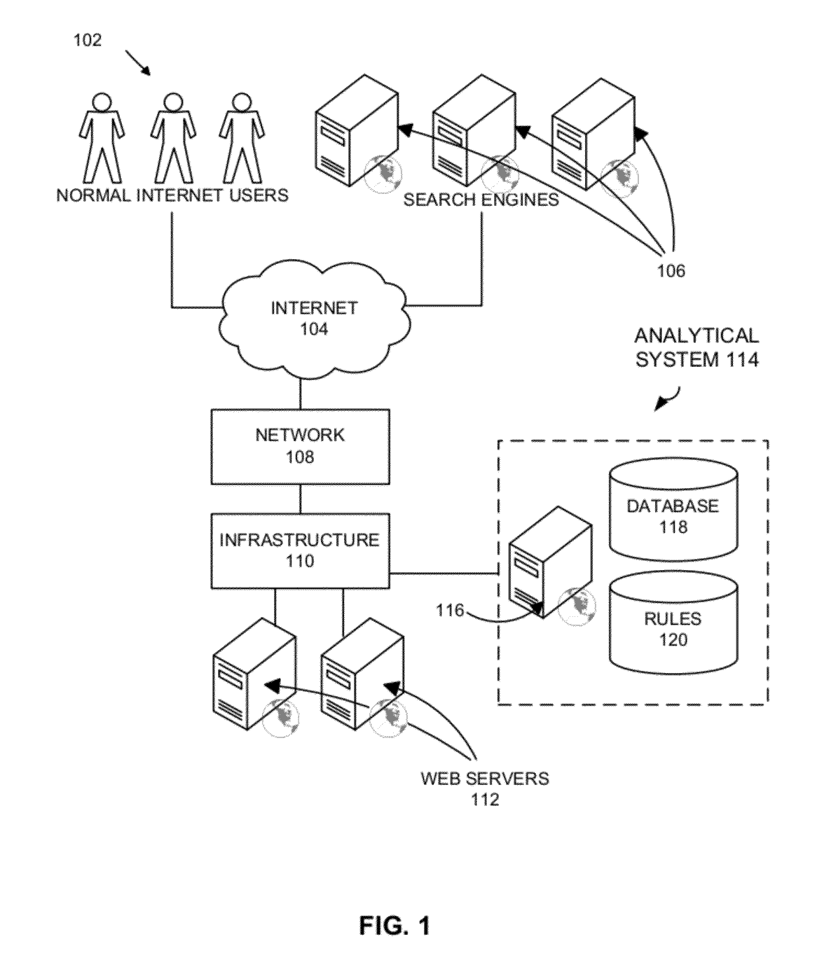

FIG. 1 is a network topology logical diagram that shows how a system in accordance with embodiments of the present disclosure would be deployed in an out of line mode. Architecture 100 includes both human and robotic users of the Internet such as normal Internet Users 102 and Search Engines 106 that perform searches on Internet 104. Internet 104 may be coupled to Network 108 with supporting Infrastructure 110 and may include Web Servers 112 as well as Analytical Systems 114. Analysis System 114 may further include a process module in computing device 116 as well as various Databases 118 and Databases 120.

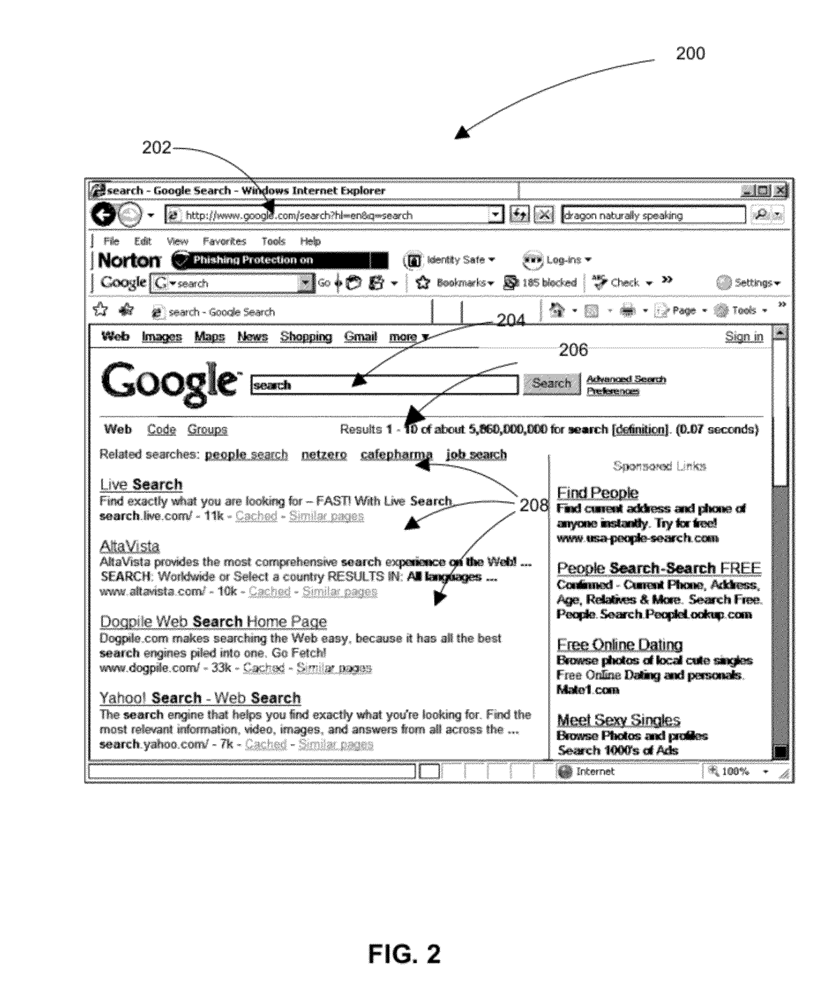

FIG. 2 provides a screenshot of an Internet Browser, which may be utilized in accordance with embodiments of the present disclosure. Browser window 200 depicts using a Search Engine 202 such as Google to input key search terms.

Referring first to FIG. 1 the normal internet user 102 is connected to the Internet 104 via a normal internet browser as seen in FIG. 2. The internet user 102 uses the browser 200 to type in a keyword search 204 into the search engine 202. The search engine 202 displays a set of results 206 in ranked order as it relates to relevance. Relevance is determined by using its spiders 106 to connect to the web server 112 via the Internet 104 and build metrics on the page content and surrounding criteria.

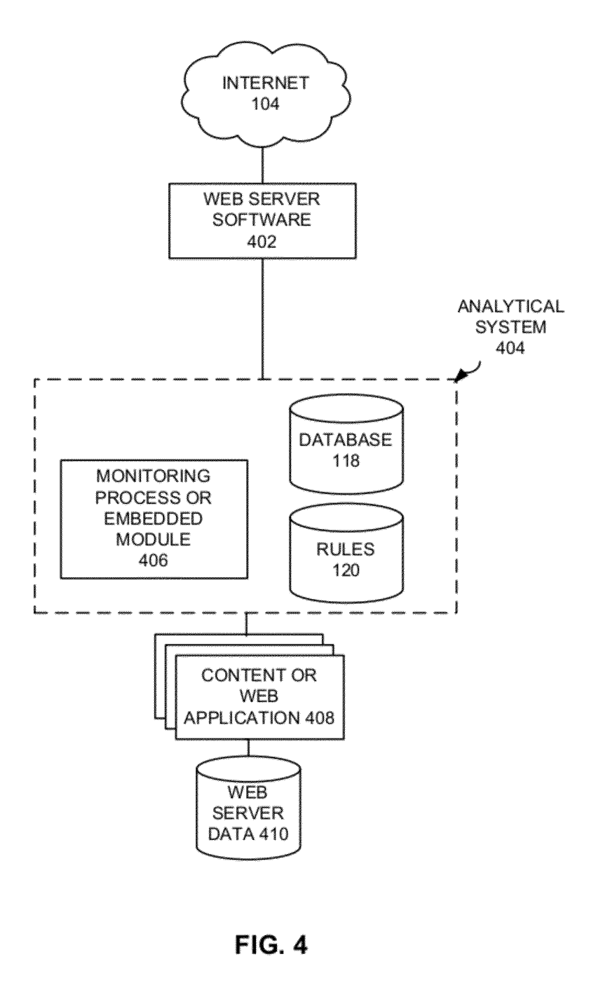

In the process of spidering the web server 112 the HTTP traffic flows over the network 108 of the company, which can include things like firewalls, routers, switches, load balancers, proxies, etc. The system 116 can read both HTTP and HTTP over SSL (HTTPS) traffic through the use of a shared SSL certificate that is installed on the device 116 prior to viewing traffic or in the case where part of the network 108 includes an SSL accelerator. The SSL certificate put on the system 116 is shared with the web servers 112 when SSL is enabled. In the case of FIG. 4 an in-memory or web server module 406 shared SSL certificates are not required as SSL traffic is already decrypted by the web server software 402.

Once both the search engine spider 106 and the internet user 102 connect to the web site hosted on servers 112 the system 116 can identify which pages 408 are valid or invalid and which pages are not being crawled effectively by storing the information in a database 118 and applying rules 120 against that information. In addition, the system 116 can identify which pages 408 are intended to be hidden from crawlers by reading and parsing the “robots.txt” file from the web server 112 as spiders 106 pull the file. In this ways, the system 116 never has a need to request pages 408 directly from the web server 112 but can instead listen passively for all the information it needs.

By identifying which pages 408 are intended to be crawled by the search engine spiders 106, the system 116 can generate sitemaps that can be used by the web site hosted on servers 112, which will alert the spiders 106 to the location of all pages 408 that the spider 106 may have missed. The system 116 and 406 also identify web server programs 408 or database 410 failures that generate errors on the web application 402. The system 116 can also identify other logical errors with the web server programs 408 or web server 402 configurations that use too many redirects or other issues that may negatively affect a spider's (crawler's) 106 ability to index the web site hosted on servers 112.

The system's 116 rules 120 are set to identify both IP ranges of known spiders 106 as well as HTTP headers that indicate a spider 106. These rules 120 can both be applied against the database 118 of known logs as well as in real-time as events are replicated from the infrastructure 110 from the Internet 104. Logs are kept in the database 118 to identify which pages have been indexed by a crawler executed by search engines 106 as well as to do rules 120 processing against them to identify which pages 408 need to be re-structured or re-written to be more attractive in terms of keyword 204 density, URL structure, location of content on the page 408 absence of descriptive meta tags and title tags and other known parameters that are attractive in varying degrees to search engines 106.

The recommendations from the system 116 are then used by the owners of the web site hosted on servers 112 to modify the web pages 408. The goal of which is to make the pages 408 more attractive to search engines 106 so the pages 408 will appear higher within a keyword 204 search result page 206.

Existing solutions provide only part of the transaction not the entire transaction. This results in prior solutions examining only the headers of the HTTP logs and not the entire transaction. Embodiments of the present disclosure provide off-to-the-side processing, in-front processing, and agent processing. As shown in FIG. 1, processing occurs to the side wherein the analytical system taps into parts of the infrastructure such as a tap to see what is being exchanged with Web Servers 112. This might be done using a span port or other that allows marrying of traffic from the infrastructure to the analytical system. This requires no man in the middle and results in no single point of failure in the implementation. This has minimally invasive provisioning or commissioning as a span port or other port that allows mirroring to occur to provide access to the analytical system.

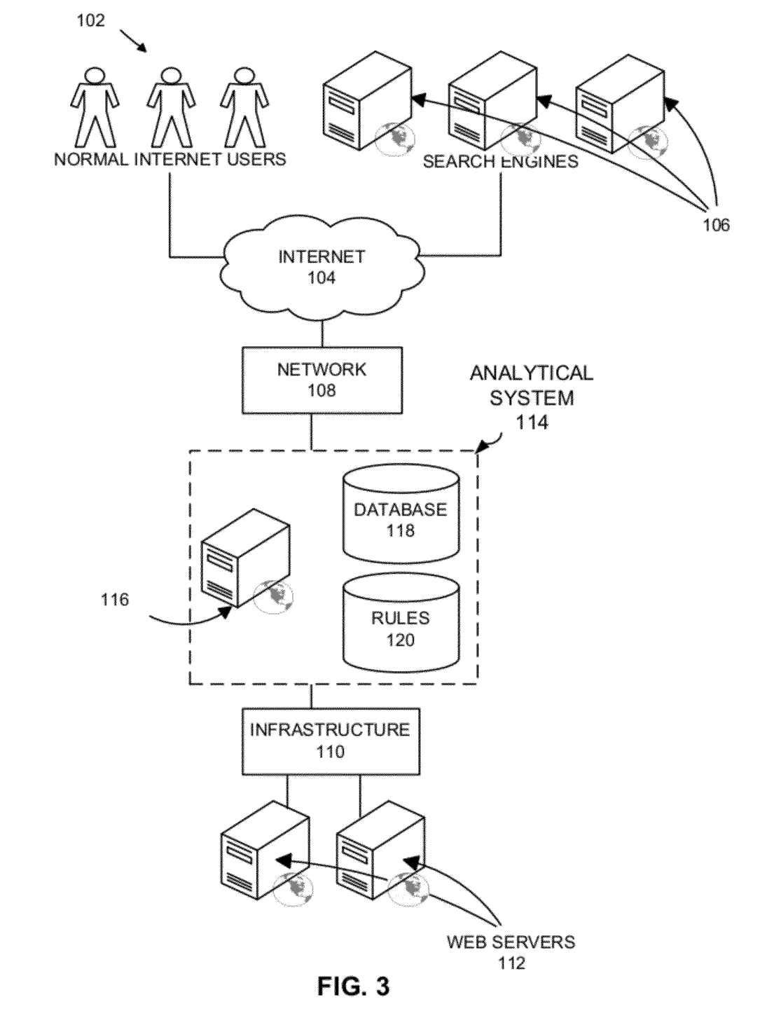

FIG. 3 is a network topology logical diagram that shows how a system in accordance with embodiments of the present disclosure would be deployed in an in line mode. In FIG. 3, the analytical system provided acts as a man in the middle, which may have additional ports or taps available. However, this system will have the data flowing to the web servers to all be processed by the analytical system. This provides an opportunity for a single point of failure, which may be less attractive from a reliability standpoint. This may be more advantageous where robotic activity is interrupted or the flow of packets or data exchanged with the web server may be interrupted.

FIG. 4 is a logical diagram explaining how embodiments of the present disclosure would be deployed as an in-memory process, or web server module. FIG. 4 depicts an embodiment of the present disclosure where an agent may reside with on the web server itself, a networking shim, or module which may plug or couple into the web server software. As a network shim, the agent may function in the same manner as disclosed in FIG. 3. The system described in FIG. 3 may provide a system to more easily change data then the system provided in FIG. 1. However, the system of FIG. 1 may accomplish the same function by using a spoofing process.

FIG. 4 depicts one network location to make outbound modifications to content. For instance if a page was either marked ahead of time with markup, and/or rules placed in the system identify opportunities to improve the page or web site content, FIG. 4 is a likely network configuration given that this location has easy access to modify content, without interrupting the site using RST packets. It is also the most optimal location for not requiring additional crypto deceleration hardware as it can all be placed within a single device to also listen to and modify HTTPS traffic by terminating the SSL/TLS session at the system's public facing interface.

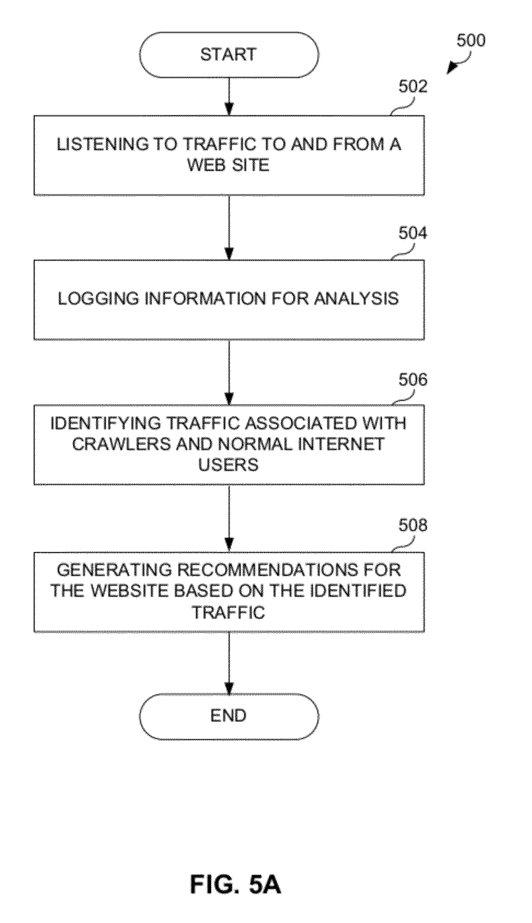

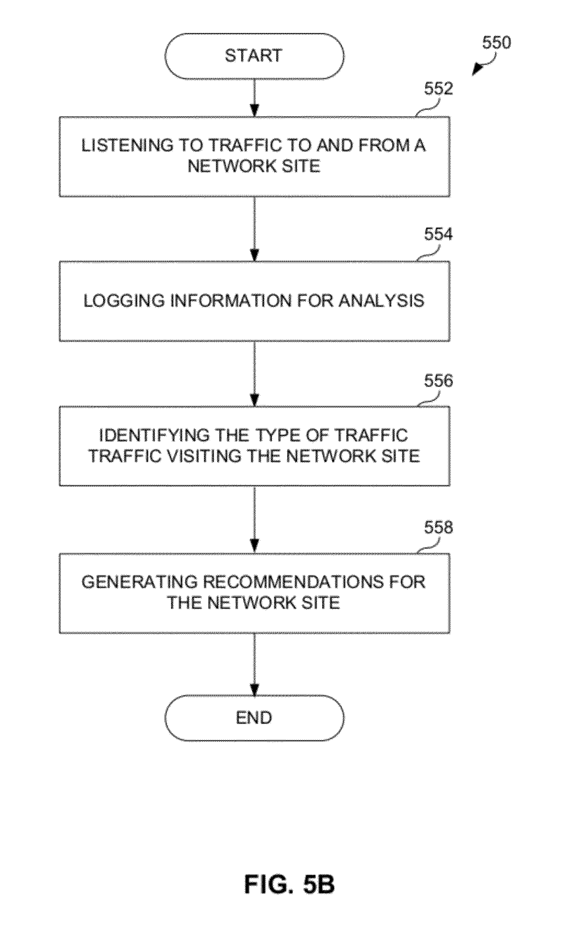

FIG. 5A provides a logic flow diagram illustrating a method for recommending optimizations to the web page based on search engine results. Operations 500 began with Block 502 where traffic to and from a web site may be listened to. This may involve passive listening to HTTP or HTTPS traffic both to and from the web site. In Block 502 the information received may be logged for long-term archival and analysis of which pages within the web site have been visited. Then in Block 506, the stored information may have a set of rules applied against it to identify activity from crawlers and activity from normal internet users. Then in Block 508 recommendations based on the results of what has been crawled by search engine crawlers and where the crawling has stopped may be produced in order to provide recommendations on how to optimize a webpage for improved results within a search engine. The webpage may be located on a web server as shown in FIGS. 1, 3 and 4.

FIG. 5B provides a logic flow diagram illustrating another method for recommending optimizations to the web page based on search engine results. Operations 550 began with Block 552 where traffic to and from a network site, such as but not limited to a web site, may be listened to. The network site has indexable content. Passively listening may involve passive listening to the data traffic that includes but is not limited to HTTP, HTTPS, NNTP or FTP traffic both to and from the network site. Passive listening may be performed by a processing module either in line, out of line or in-memory on the network site as shown in FIGS. 1, 3 and 4. In Block 552 the data (information) received may be logged for long-term archival and analysis of which pages within the network site have been visited and results associated with the pages (content) visited. The analysis may involve determining a score associated with the data traffic and the network pages visited. Changes to the network site may be manually logged for analysis of the data traffic and results associated with pages visited. This analysis may also examine changes to a referring network site for analysis of which pages have been visited.

The type of user visiting the network site may be identified from the data traffic in block 556. In one example, the type of user is a bot or a human. Rules for identifying the type of user may be based on IP location and packet data of search engine bots. Alternatively, rules for identifying the type of user may be based on headers of known search engine bots.

Block 558 generates recommendations for optimizing the network content based on the analysis and results. These recommendations may include changes to keywords or metadata based on the score.

Other embodiments may further reconfigure the network site in real time based on the data traffic or type of user visiting the network site. The network page may be located on the network server, as shown in FIGS. 1, 3 and 4, the network page can be seen via either a device in the infrastructure or an in-memory process or module. Digital security certificates are shared with the network site, the security certificates. The digital security certificates may include but are not limited to Secure socket layer (SSL) certificates, Extended Validation (EV) SSL certificates, Transport Layer Security (TSL) certificates, and Cryptographic certificates.

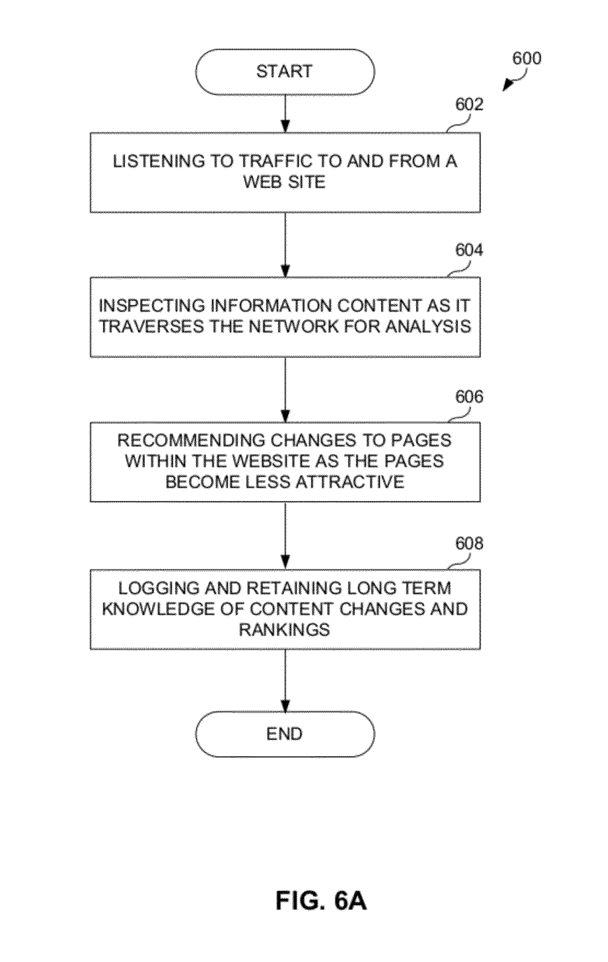

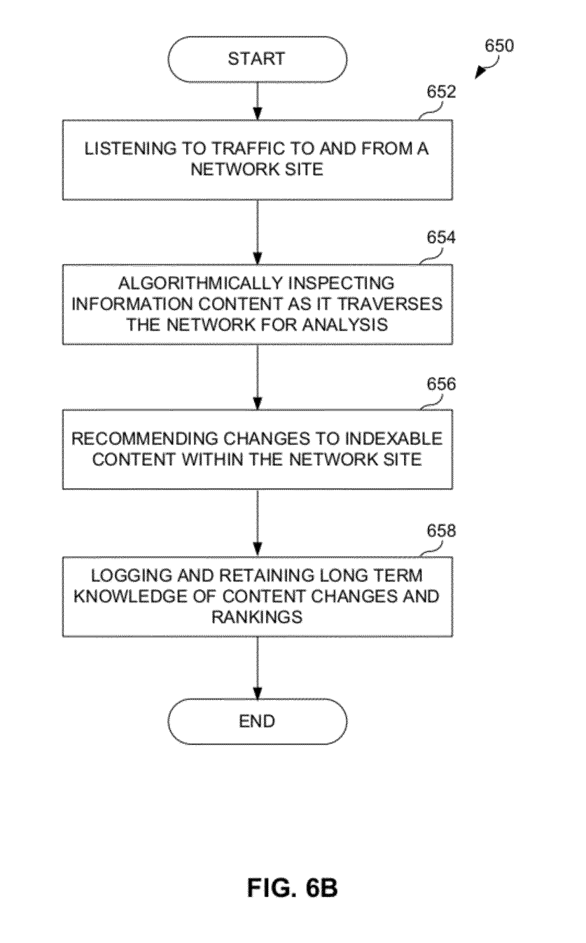

FIG. 6A provides a logic flow diagram in accordance with embodiments of the present disclosure of a method of making recommendations to improve page rankings within search engine results. Operation 600 beginning with Block 602 where traffic traversing the network of a web site may be listened to in either a passive or an active manner. In Block 604, the content of the information as it traverses over the network may be inspected in both real time and post processing. In Block 606 recommendations to change pages as they are detected to be less attractive to search engine spiders may be recommended. In Block 608, long-term statistical knowledge of changes to the web server content and its affect on search engine results may be logged and retained.

FIG. 6B provides a logic flow diagram in accordance with embodiments of the present disclosure of a method of making recommendations to improve page rankings within search engine results. Operation 650 beginning with Block 652 where traffic traversing a network hosting a network site having indexable content may be listened to in either a passive or active manner. The network site having indexable content may be: a web site; an FTP site; an NNTP site; or a Gopher Index site.

In Block 654, the content of the information as it traverses over the network may be algorithmically inspected in both real time and post processing. Block 656 recommends changes to improve individual indexable content rankings on search engine results pages for indexable content within the network site when the indexable content is determined to compare unfavorably to a threshold level with search engine bots. In Block 658, long-term statistical knowledge of changes to the network site content as the content changes over time and its affect on search engine results may be logged and retained.

Construction of a sitemap is based on a delta between internet users and search engine bots as well as removing sensitive pages from the sitemap as described in the robots.txt file. A number and location of links, which search engine bots have indexed the links and with what frequency are the links indexed, may be tracked to determine how search engine bot behavior changes over time.

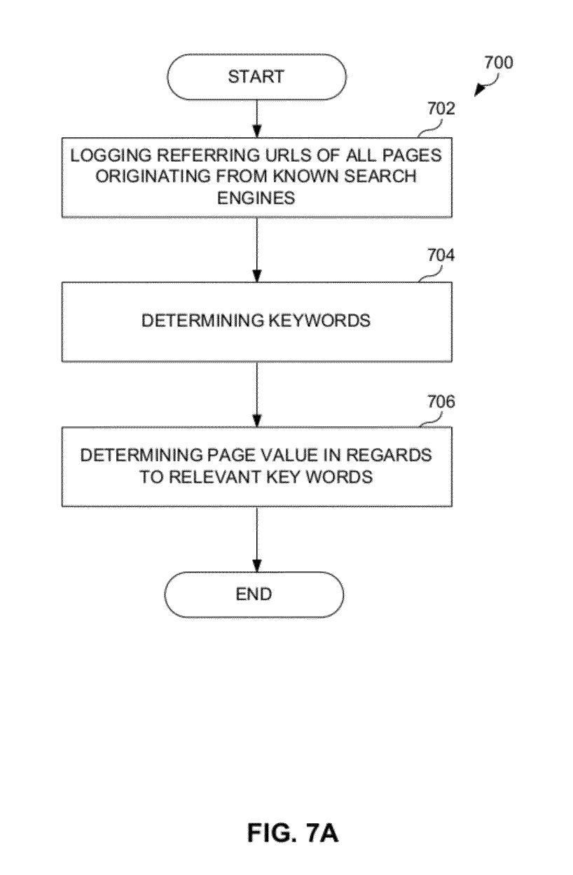

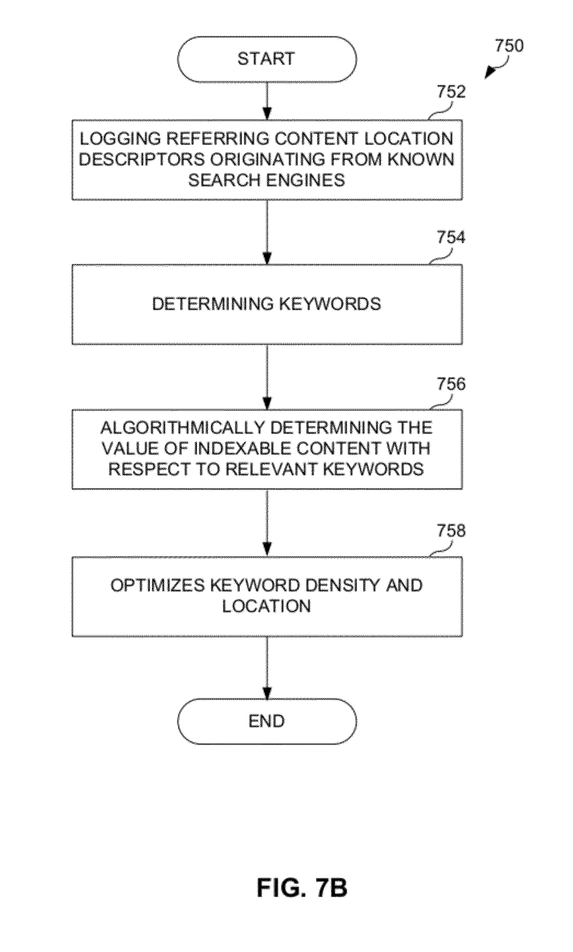

FIG. 7A provides a logic flow diagram of a method of optimizing keyword to understand the location based on the location and keywords on a web site page in accordance with embodiments of the present disclosure. Operations 700 begin with Block 702 wherein logging or referring URLs of all pages originating from known search engines occurs. Then in Block 704, keywords are determined based on search engine referring URLs as well as user-inputted high value keywords. Then in Block 706, the value of each page with respect to relevant keywords may be determined. This may also include determining whether traffic comprises new end users or robotic activity.

FIG. 7B provides a logic flow diagram of a method of optimizing keyword to understand the location based on the location and keywords on a network site page in accordance with embodiments of the present disclosure. Operations 750 begin with Block 752 wherein logging referring content location descriptors (such as but not limited to URLs) originating from known search engines occurs. Then in Block 754, keywords are determined based on search engine referring content location descriptors as well as user-inputted high value keywords. Then in Block 756 algorithmically determines the value of indexable content (pages) with respect to relevant keywords. This may also include determining whether traffic comprises new end users or robotic activity. Block 758 optimizes keyword density and location based how valuable indexable content is in regards to the relevant keywords.

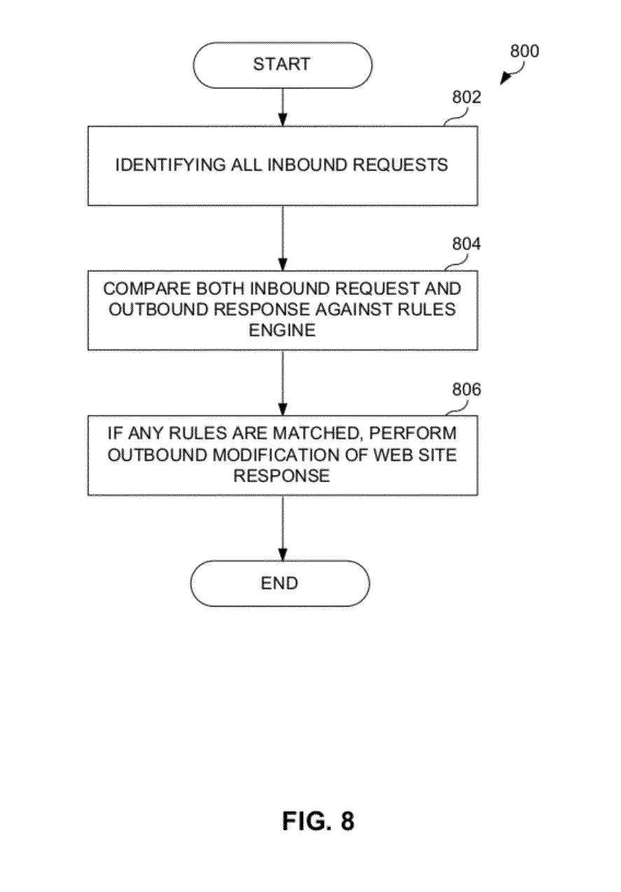

FIG. 8 provides a logic flow diagram of a method of modifying outbound responses from the web server for the purpose of improving page construction for page load time optimization, adding third party in line widgets, or improving the search engine value of the page. Operation 800 begins with Block 802 wherein identifying and dissecting inbound request. Then in block 804, the system identifies if the page matches any rules associated with content modification. Once the page is returned to the system, it is again tested against any existing rules for content modification in block 806. If either block 804 or 806 are true, the content is modified or substituted as the rules dictate and the content is then returned successfully to the requestor.

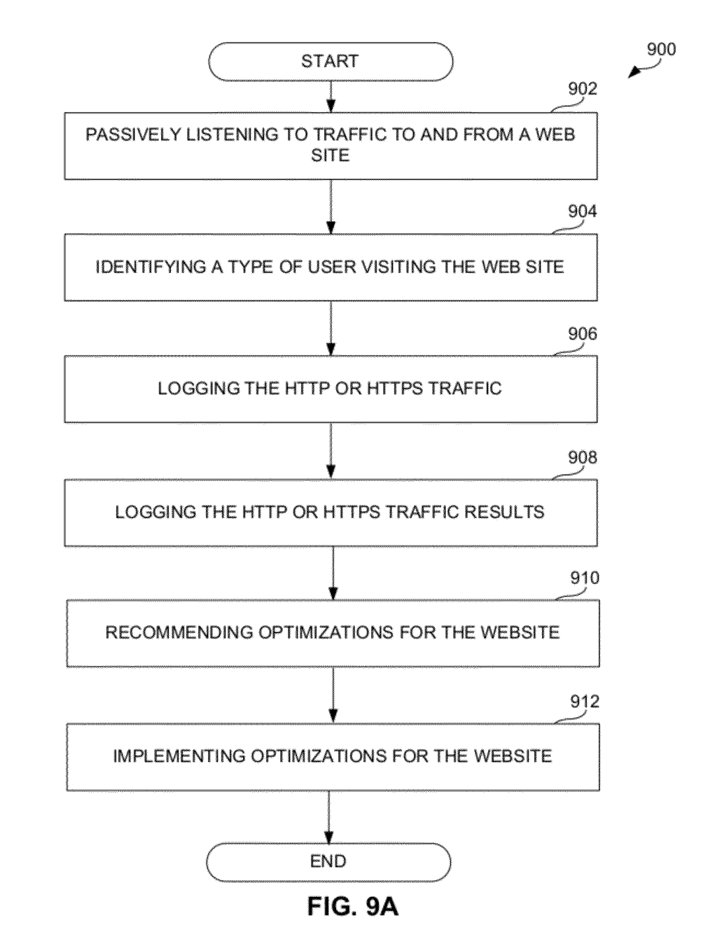

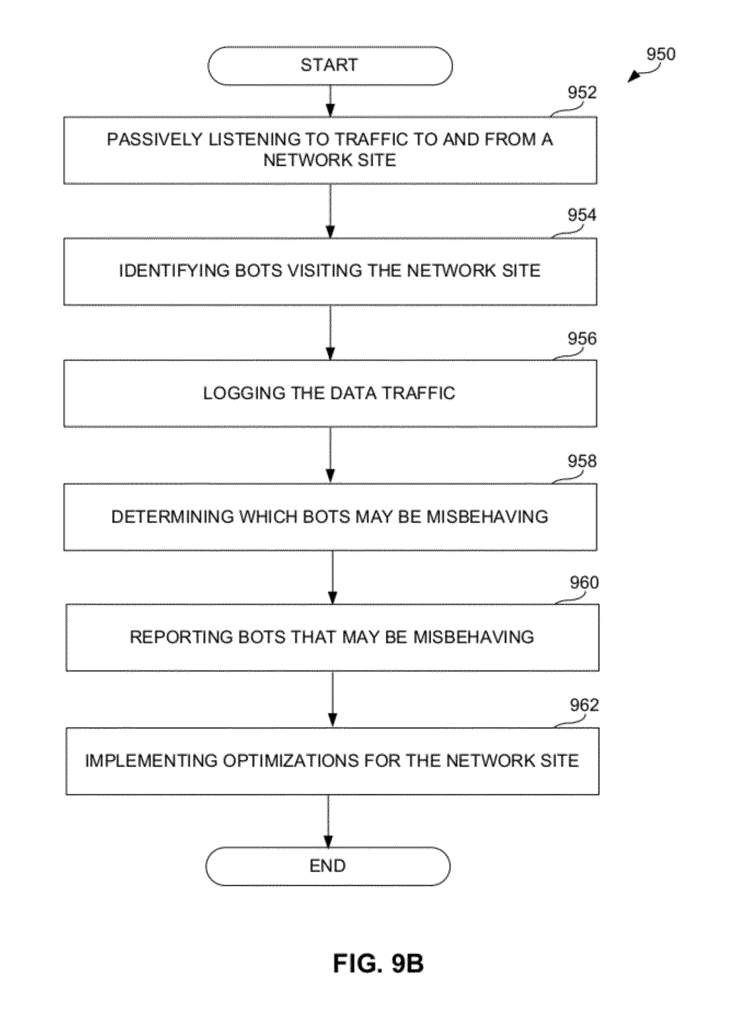

FIG. 9A provides a logic flow diagram associated with method of optimizing web sites in accordance with embodiments of the present disclosure. Operations 900 begin with Block 902 where a processing module passively listens to traffic to and from a web site. In Block 904, it may be optionally determined what type of user is visiting the web site. This user may be a human or a robotic user such as a spider or crawler. Furthermore, this type of user may be determined to be a good user, benign user, or malevolent user. In Block 906, the HTTP or HTTPS traffic is logged. In Block 908, the traffic results are logged. These may be analyzed such that in Block 910 recommendations for optimizations for the web site in order to improve traffic and results to the web site may be determined and then implemented in Block 912.

FIG. 9B provides a logic flow diagram associated with method of optimizing network sites in accordance with embodiments of the present disclosure. Operations 900 begin with Block 902 where a processing module passively listens to traffic to and from a network site. In Block 904 identifies bots visiting the network site by passively listening. Furthermore, the type of bot may be determined to be a good user, benign user, or malevolent user. In Block 906, the data traffic is logged for analysis of what content has been visited by the bots and results associated with the indexable content that has been visited. Block 908 determines which bots may be mis-behaving. Then a report of mis-behaving bots may be produced in block 960. Block 962 may modify the indexable content based on analysis of data traffic visited by the bots. Further operations may include: determining bot activity based on listening to data traffic and algorithmically determining valid users; and detecting the location of indexable content that should be off limits to the bots based on robots.txt.

The flowchart and block diagrams in the FIGs. illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the FIGs. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The disclosure can take the form of an entirely hardware embodiment, an entirely software embodiment or an embodiment containing both hardware and software elements. In a preferred embodiment, the disclosure is implemented in software, which includes but is not limited to firmware, resident software, microcode, etc.

Furthermore, the disclosure can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

In summary, the present disclosure provides a method for determining the value of a given page or pages in aggregate to a search engine based on key-word search results and optional modification of site content and layout to improve search engine rankings or page construction. A listening system is inserted within the network for the purpose of listening to both inbound to and outbound traffic from the web server and optionally modifying outbound responses. The device uses an algorithm to decide the relative value of the page as it is traversed. The system also detects web server errors, scanning depth of the search engine and makes recommendations based on the examined traffic and desired results. Human visitors are distinguished from search engines by looking at the HTTP headers and therefore search engine depth and effectiveness in page scanning can be calculated.

As one of average skill in the art will appreciate, the term “substantially” or “approximately”, as may be used herein, provides an industry-accepted tolerance to its corresponding term. Such an industry-accepted tolerance ranges from less than one percent to twenty percent and corresponds to, but is not limited to, component values, integrated circuit process variations, temperature variations, rise and fall times, and/or thermal noise. As one of average skill in the art will further appreciate, the term “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of average skill in the art will also appreciate, inferred coupling (i.e., where one element is coupled to another element by inference) includes direct and indirect coupling between two elements in the same manner as “operably coupled”. As one of average skill in the art will further appreciate, the term “compares favorably”, as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The terminology used herein is for describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A method comprising:
passively listening to data traffic associated with a networked site, the networked site having indexable content;
identifying a type of user visiting the networked site from the data traffic;
logging the data traffic for analysis of which content has been visited and results associated with the content that has been visited; and
recommending optimizations to content based on the analysis and results.

2. The method of claim 1, wherein the data traffic comprises HTTP, HTTPS, NNTP or FTP traffic.

3. The method of claim 1, wherein the passive listening is performed by a processing module either in line, out of line or in-memory on the networked site.

4. The method of claim 1, further comprising determining a score associated with the data traffic and the content that has been visited.

5. The method of claim 4, wherein changes to keywords or metadata are optimized based on the score.

6. The method of claim 1, further comprising reconfiguring the networked site in real time based on the traffic.

7. The method of claim 1, further comprising reconfiguring the networked site in real time based on the type of user visiting the networked site.

8. The method of claim 1, wherein changes to the networked site are manually logged for analysis of the data traffic and results associated with content visited.

9. The method of claim 8, wherein changes to a referring networked site are marked for analysis of which content has been visited.

10. The method of claim 1, where in the content is located on the network server which can be seen via either a device in the infrastructure or an in-memory process or module.

11. The method of claim 1 where digital security certificates are shared with the networked site, and a device.

12. The method of claim 11 wherein the digital security certificates are selected from the group consisting of:
Secure socket layer (SSL) certificates;
Extended Validation (EV) SSL certificates;
Transport Layer Security (TSL) certificates; and
Cryptographic certificates.

13. The method of claim 1 where the system has access to log information for long term archival and processing.

14. The method of claim 1, wherein the type of user is a bot or a human.

15. The method of claim 14, where rules for identifying the type of user are based on IP location and packet data of search engine bots.

16. The method of claim 14, where rules for identifying the type of user are based on headers and/or traffic signature of known search engine bots.

17. A method comprising:
listening for traffic as the traffic traverses a network hosting a networked site having indexable content;
algorithmically inspecting content within the traffic as the traffic traverses over the network in real time and/or in post processing;
recommending changes to improve individual indexable content rankings on search engine results pages for indexable content within the networked site when the indexable content is determined to compare unfavorably to a threshold level with search engine bots; and
logging and retaining long term statistical knowledge of changes to the networked site content as the content changes over time.

18. The method of claim 17, wherein the networked site having indexable content may comprise:
a web site;
an FTP site;
an NNTP site; or
a Gopher Index site.

19. The method of claim 17 where construction of a sitemap is based on a delta between internet users and search engine bots as well as removing sensitive pages from the sitemap as described in the robots.txt file.

20. (canceled)

21. (canceled)

22. A method comprising:
logging referring content location descriptors originating from known search engines;
determining keywords based on search engine referring content location descriptors as well as user inputted high value keywords;
algorithmically determining how valuable indexable content is in regards to the relevant keywords or content attributes; and
optimizing keywords density or content attributes and location based how valuable indexable content is in regards to the relevant keywords or content attributes.

23-30. (canceled)
